(19) United States
(12) Patent Application Publication
(10) Pub. No.: US 2007/0194541 A1
(43) Pub. Date: Aug. 23, 2007

(54) Self-loading vehicle for use with sloped terrain

(76) Inventor: Ludwig von Maldeghem, Calgary (CA)

Correspondence Address: GOWLING LAFLEUR HENDERSON LLP, SUITE 1400, 700 2ND ST. SW, CALGARY, AB, T2P 4V5, CA

(21) Appl. No.: 11/359,557

(22) Filed: Feb. 23, 2006

(51) Int. Cl. B62B 19/00

(52) U.S. Cl. 280/16

(57) ABSTRACT

A self-loading recreational vehicle for use with sloped terrain having lift means such as a chair lift, the vehicle comprising at least one terrain contact member such as a ski or snowboard attachment, and a recess in the vehicle frame for accepting the lift means; the recess may be a gap between the seat and adjacent frame elements. Also, a vehicle-modifying kit comprising a seat mounting bracket for connection to the vehicle frame, and a seat for connection to the seat mounting bracket at a connection point, the connection point being located forwardly on an undersurface of the seat.

### FIELD OF THE INVENTION

The present invention relates to recreational and sports equipment, and more particularly to improvements to recreational equipment for use with sloped terrain.

### BACKGROUND OF THE INVENTION

Skibikes have been in existence for approximately 150 years, taking various forms and spawning a sport based on this recreational vehicle. Also known as snowbikes, skibobs and boardbikes, the vehicles are primarily intended as recreational vehicles for use on sloped terrain that has a snow covering. Beginning as simple modifications to existing bicycles or “velocipedes” in the mid-nineteenth century (see, for example, U.S. Pat. Nos. 95,521 to Searing and U.S. Pat. No. 534,574 to Parsons et al.), skibikes have now evolved into independently designed recreational vehicles (see, for example, U.S. Pat. No. 3,682,495 to Zaimi).

During the period of the development of the skibike, ski lifts have evolved from surface lifts to predominantly chair lifts. Given this evolution, the common lift loading methods for skibikes now include lap loading, arm rest hooks, hooks on chair lifts, and many other variations. However, all of these methods have proven cumbersome, some have required extra staff, and all have certain limitations and safety concerns. The offloading of chair lifts has also presented a problem; most of the offloading methods have seen the rider either skiing down the offloading ramp with their foot skis, carrying the skibike, or running down the offloading ramp while carrying the skibike. The industry has been looking for a safe and easy way to load and offload skibikes on and off chair lifts without taking up more than one space on a chair lift and without adding extra staff and a change in lift loading and unloading procedures.

In addition, existing loading and offloading methods have proven extremely difficult or completely unworkable for persons with physical disabilities. Although the skibike can provide a viable form of recreation for persons with certain physical disabilities, the existing lift means can effectively nullify this opportunity.

What is needed, therefore, is a novel skibike that can address the limitations imposed by the existing lift technology, and the means to modify existing skibikes to address these limitations.

### SUMMARY OF THE INVENTION

The present invention accordingly seeks to provide a novel recreational vehicle for use with snow-laden sloped terrain which can interface easily and effectively with existing lift mechanisms.

According to a first aspect of the present invention there is provided a vehicle for use with sloped terrain, the sloped terrain being provided with lift means for carrying the vehicle to an uphill location on the sloped terrain, the vehicle comprising:
a frame;
at least one terrain contact member connected to the frame; and
a recess in the frame for accepting the lift means.

In exemplary embodiments of the first aspect, the frame comprises a seat for user occupation, the seat connected to adjacent frame, the recess being formed by a gap between the seat and the adjacent frame. The seat preferably connects to the adjacent frame by a connecting member, the connecting member positioned forwardly on and connected to a bottom surface of the seat at a connection location to enable unobstructed receipt of the lift means in the gap. The vehicle preferably comprises steering means connected to the frame. The at least one terrain contact member preferably comprises at least one elongate member for engaging the sloped terrain when the sloped terrain is covered with snow, and where the vehicle comprises steering means the at least one terrain contact member preferably comprises at least one elongate member connected to a rearward portion of the frame and at least one elongate member connected to the steering means. The at least one terrain contact member is preferably selected from the group consisting of a ski-shaped member, a snowboard-shaped member, at least two ski-shaped members, at least two snowboard-shaped members, and a combination of ski-shaped and snowboard-shaped members. Also, the seat where present is preferably pivotable about a horizontal axis at the connection location and biasing means are disposed adjacent the connecting member to bias the seat in a generally horizontal orientation.

According to a second aspect of the present invention there is provided an improved vehicle for use with sloped terrain provided with lift means for carrying the vehicle to an uphill location, the vehicle comprising a frame with means for engaging the sloped terrain, the improvement comprising providing a recess in the frame for receiving the lift means.

In exemplary embodiments of the second aspect, the recess comprises a gap between a seat member and adjacent frame elements, the seat being pivotably connected to the adjacent frame elements by a forwardly-located connecting bracket and biased in an upward position by biasing means, the gap opening in a rearward direction.

According to a third aspect of the present invention there is provided a kit for modifying a vehicle configured for use on sloped terrain where the sloped terrain is provided with a lift mechanism for carrying the vehicle up the sloped terrain, the vehicle comprising a frame with at least one terrain-engaging member, the kit comprising:
a seat mounting bracket for connection to the frame; and
a seat for connection to the seat mounting bracket at a connection point, the connection point being located forwardly on an undersurface of the seat.

In exemplary embodiments of the third aspect, the seat may be pivotably connected to the seat mounting bracket at the connection point, the kit then further comprising a biasing member for connecting the frame and the undersurface of the seat, the biasing member for biasing the seat toward a generally horizontal orientation. The seat mounting bracket may be for pivotable connection to the frame, and then most preferably the kit further comprises a biasing member for connecting the frame and the seat mounting bracket, the biasing member for biasing the seat toward a generally horizontal orientation.

A recreational vehicle according to the present invention, therefore, can effectively solve the operational issues and problems of transporting skibikes on chair lifts efficiently and safely. This is accomplished by a novel vehicle which enables loading the skibike and rider onto a chair lift while the rider is sitting on the skibike, as the chair lift can go under the seat of the skibike to scoop the rider and the skibike up on the chair lift.

The advantages include being able to load lifts without taking up more than one space on a chair lift, and there are no modifications necessary to the chair lifts or to the lift loading procedures. Safety is much improved since the rider is sitting on the skibike seat on the chair lift and the safety bar can be lowered to hold the bike and rider in the lift. The unloading is also much easier and safer since the rider is already sitting on the skibike upon offloading.

A detailed description of an exemplary embodiment of the present invention is given in the following. It is to be understood, however, that the invention is not to be construed as limited to this embodiment.

### BRIEF DESCRIPTION OF THE DRAWINGS

In the accompanying drawings, which illustrate an exemplary embodiment of the present invention:

FIG. 1 is a front perspective view of a first embodiment of the present invention;

FIG. 2 is a side elevation view of the first embodiment;

FIG. 3 is a simplified side elevation view of the first embodiment when engaged by the lift means;

FIG. 4 is a simplified side elevation view of a second embodiment of the present invention when engaged by the lift means;

FIG. 5 is a simplified side elevation view of the first embodiment when engaged by the lift means, with a rider in position;

FIG. 6 is a simplified side elevation view of the second embodiment when engaged by the lift means, with a rider in position; and

FIG. 7 is a front perspective view of a third embodiment of the present invention.

### DETAILED DESCRIPTION OF A PREFERRED EMBODIMENT

Referring now in detail to the accompanying drawings, there are illustrated three exemplary embodiments of a vehicle according to the present invention, the vehicle generally referred to by the numeral 10.

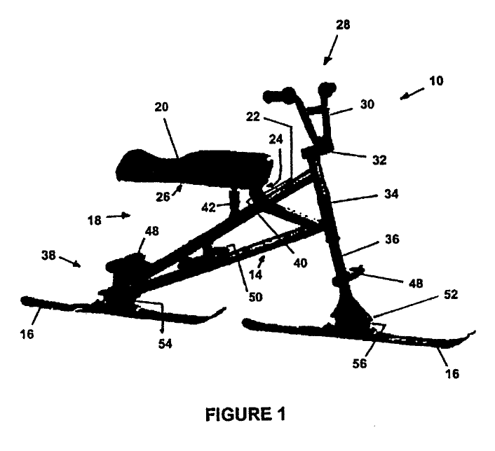

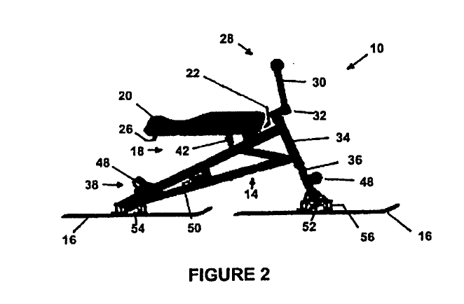

Referring to FIGS. 1 and 2, a first embodiment of the present invention is illustrated, for use with sloped terrain (not shown) with adequate snow cover (not shown). The vehicle 10 comprises a frame 14 and two terrain contact members 16, which in this embodiment are front and rear ski members (although other forms, such as snow-board-shaped members, are possible). The front contact member 16 is connected to the steering means 28 and can be rotated thereby. The steering means 28 comprise handlebars 30, a stem 32, a headset 34, and the steering column 36, elements well known in the art of bicycle design. The rear contact member 16 is connected to the frame 14 at a rearward portion 38, but this contact member 16 is not steerable. Each of the contact members 16 is pivotably connected to the frame 14 at a pivot member 52, 54, and the pivot members 52, 54 are also provided with bumpers 56. In this embodiment, bumpers 56 are situated in front of and behind each of the pivot members 52, 54, limiting the pivot range of the contact member 16 and helping to keep the contact member 16 generally horizontal. Bumpers 56 can take any number of forms, including springs.

The vehicle 10 is further provided with a seat 20 to enable a rider (not shown) to rest on the frame 14 during operation of the vehicle 10. A connection location 24 is situated forwardly on the undersurface 26 of the seat 20, and a connecting bracket 22 is mounted at the connection location 24 to connect the seat 20 and the frame 14. The connecting bracket 22 comprises a pivot 40 to enable the seat 20 to pivot in a generally horizontal plane relative to the frame 14. In addition, the vehicle 10 is provided with biasing means 42, in this embodiment a simple shock member, to bias the seat 20 upwards and away from the seat 20, in a manner well known to those skilled in the art. As with the connection location 24, the biasing means 42 connect to the undersurface 26 of the seat 20 at a point forwardly on the undersurface 26.

As both the connection location 24 and the biasing means 42 are positioned forwardly on the undersurface 26 of the seat 20, a recess or gap 18 is accordingly formed between the seat 20 and the rest of the frame 14. In standard skibikes, the seat connection and any biasing mechanism are generally positioned centrally on the seat undersurface, or are spread across the undersurface.

In addition, the frame 14 is provided with foot pegs 48 and pedals 50 for use as foot rests. However, foot pegs 48 and pedals 50 are not normally used where the rider has boots provided with outrigger skis (not shown), small skis which are used to stabilize and control the vehicle 10. A rider could, though, choose to rest the outrigger-fitted boots on the foot pegs 48 or pedals 50 to enhance speed on straight runs.

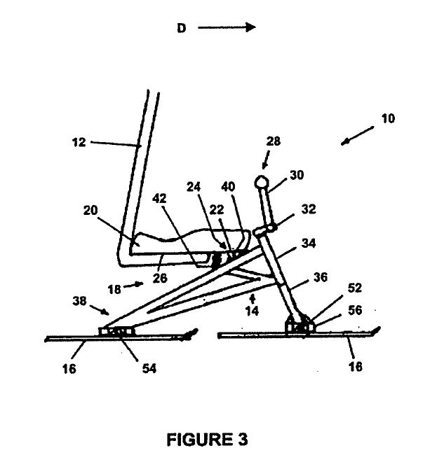

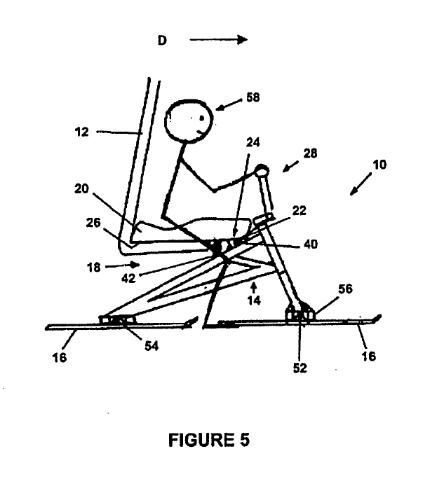

Referring now to FIGS. 3 and 5, which further illustrate the embodiment of FIGS. 1 and 2, the advantages of such an arrangement become clear. As mentioned above, both the connection location 24 and the biasing means 42 are positioned forwardly on the undersurface 26 of the seat 20, such that a recess or gap 18 is formed between the seat 20 and the rest of the frame 14. Where a rider 58 is seated on the vehicle 10, the lift means in the form of a chair lift 12 will move in a direction D to approach the vehicle 10 from the rear. Given the presence of the recess or gap 18, the chair lift 12 can engage the recess 18 and exert an upward force directly beneath the rider 58, lifting the rider 58 and vehicle 10 toward an uphill location on the sloped terrain. Standard skibikes do not embody the structure necessary to provide such an advantage, as there is no suitable recess or gap within the frame or between the seat and the adjacent frame elements.

It will be clear that there must be sufficient clearance under the seat 20, or the seat 20 must curve up at the back, to allow the chair lift 12 to slide under the seat 20 and the vehicle 10 to slide far enough back onto the chair lift 12 for the safety bar (not shown) to lower completely.

The rider 58 preferably sits on the vehicle 10 as the chair lift 12 approaches. The rider 58 can hold the handle bars 30 with one hand while turning to watch the lift 12 as it slides under the seat 20. Once the lift 12 is fully engaged under the seat 20 the rider 58 and vehicle 10 are scooped off the loading ramp (not shown) and the rider 58 is now sitting on the vehicle 10 on the chair lift 12. The rider 58 can now lower the safety bar (not shown). At the uphill location, the rider 58 then lifts the safety bar and upon touchdown on the offloading ramp (not shown) leans forward and pushes with the back of the knees, and the vehicle 10 slides off the chair lift 12 and the rider 58 is now riding down the ramp.

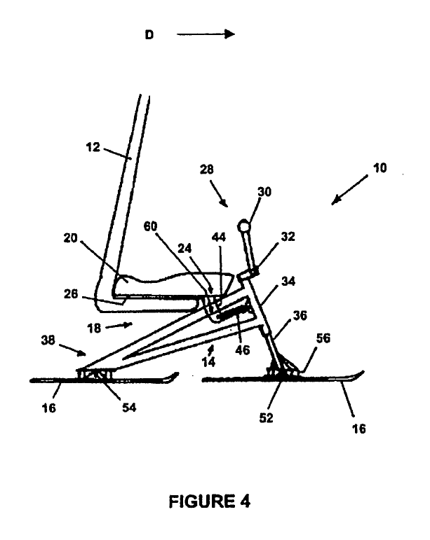

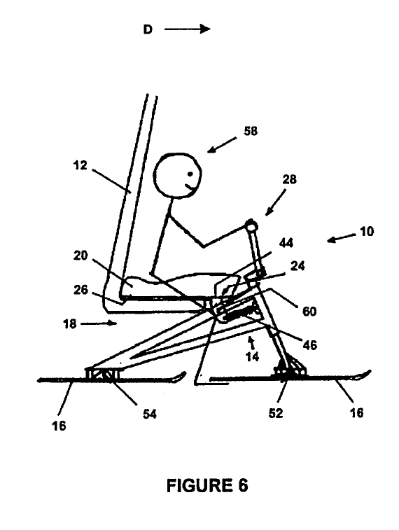

Referring now to FIGS. 4 and 6, an alternative embodiment of the present invention is illustrated. Again, the vehicle 10 comprises a frame 14 with steering means 28 and contact members 16 connected at pivots 52, 54. The seat 20 is connected to the frame 14 by means of a connecting bracket 44 which is attached to the seat 20 at the forward connection location 24 on the undersurface 26. In this embodiment, the connecting bracket 44 itself is pivotally connected to the frame 14 at a pivot 60 and pivots with the seat 20, and the biasing means 46 link the frame 14 and the connecting bracket 44. As was the case with the embodiment of FIG. 1, a recess or gap 18 is formed which can receive the chair lift 12 which moves in a direction D toward the vehicle 10, and the rider 58 can be seated on the vehicle 10 during the loading and offloading process.

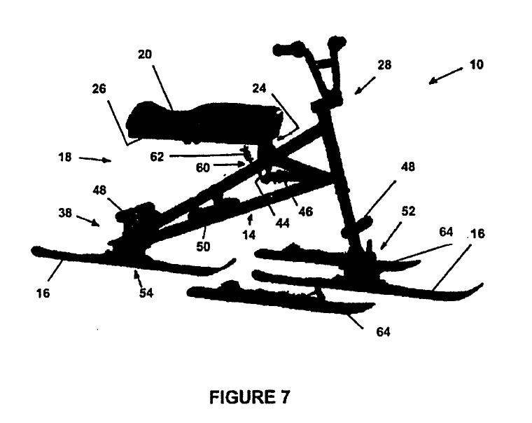

A third embodiment of the present invention is illustrated in FIG. 7. While similar in other respects to the first and second embodiments, the third embodiment differs in the arrangement of biasing means. The vehicle 10 of FIG. 7 comprises a connecting bracket 44 and biasing means 46 akin to that illustrated in FIG. 4, but in this third embodiment there is an additional biasing member 62 acting directly on the seat 20 itself. Also, outrigger skis 64 are shown at either side of the vehicle 10. It will be clear to one skilled in the art that a variety of modifications to the connecting members and biasing means are possible within the scope of the present invention.

In addition, the present invention may be practiced as a kit for modifying a standard vehicle (although not shown in isolation, the elements of such a kit are clearly shown in the Figures). Given a standard vehicle, such a kit would comprise a seat mounting bracket for connection to the frame, and a seat for connection to the seat mounting bracket at a connection point, the connection point being located forwardly on an undersurface of the seat. Referring to FIG. 1, the seat could be pivotably connected to the seat mounting bracket 22 at the connection point 24, the kit then further comprising a biasing member 42 for connecting the frame and the undersurface of the seat, the biasing member 42 for biasing the seat toward a generally horizontal orientation. Alternatively, and with reference to the embodiment of FIG. 4, the seat mounting bracket 44 could be for pivotable connection to the frame of the standard vehicle, and the kit could further comprise a biasing member 46 for connecting the frame and the seat mounting bracket 44, the biasing member 46 for biasing the seat toward a generally horizontal orientation. There are many different skibike designs currently on the market, however, so any conversion kit would require development based on the particular frame geometry and measurements, as would be obvious to one skilled in the art based on the teachings contained herein.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. For example, where a vehicle is not provided with a seat, the recess for receiving the lift means can simply comprise a rearwardly positioned gap in the frame itself. The invention is therefore to be considered limited solely by the scope of the appended claims.

1. A vehicle for use with sloped terrain, the sloped terrain being provided with lift means for carrying the vehicle to an uphill location on the sloped terrain, the vehicle comprising:
a frame;
at least one terrain contact member connected to the frame; and
a recess in the frame for accepting the lift means.

2. The vehicle of claim 1 wherein the frame comprises a seat for user occupation, the seat connected to adjacent frame, the recess being formed by a gap between the seat and the adjacent frame.

3. The vehicle of claim 2 wherein the seat connects to the adjacent frame by a connecting member, the connecting member positioned forwardly on and connected to a bottom surface of the seat at a connection location to enable unobstructed receipt of the lift means in the gap.

4. The vehicle of claim 1 further comprising steering means connected to the frame.

5. The vehicle of claim 1 wherein the at least one terrain contact member comprises at least one elongate member for engaging the sloped terrain when the sloped terrain is covered with snow.

6. The vehicle of claim 4 wherein the at least one terrain contact member comprises at least one elongate member connected to a rearward portion of the frame and at least one elongate member connected to the steering means.

7. The vehicle of any one of claims 1 to 6 wherein the at least one terrain contact member is selected from the group consisting of a ski-shaped member, a snowboard-shaped member, at least two ski-shaped members, at least two snowboard-shaped members, and a combination of ski-shaped and snowboard-shaped members.

8. The vehicle of claim 3 wherein the seat is pivotable about a horizontal axis at the connection location and biasing means are disposed adjacent the connecting member to bias the seat in a generally horizontal orientation.

9. An improved vehicle for use with sloped terrain provided with lift means for carrying the vehicle to an uphill location, the vehicle comprising a frame with means for engaging the sloped terrain, the improvement comprising providing a recess in the frame for receiving the lift means.

10. The improved vehicle of claim 9 wherein the recess comprises a gap between a seat member and adjacent frame elements, the seat being pivotably connected to the adjacent frame elements by a forwardly-located connecting bracket and biased in an upward position by biasing means, the gap opening in a rearward direction.

11. A kit for modifying a vehicle configured for use on sloped terrain where the sloped terrain is provided with a lift mechanism for carrying the vehicle up the sloped terrain, the vehicle comprising a frame with at least one terrain-engaging member, the kit comprising:
a seat mounting bracket for connection to the frame; and
a seat for connection to the seat mounting bracket at a connection point, the connection point being located forwardly on an undersurface of the seat.

12. The kit of claim 11 wherein the seat is pivotably connected to the seat mounting bracket at the connection point, the kit further comprising a biasing member for connecting the frame and the undersurface of the seat, the biasing member for biasing the seat toward a generally horizontal orientation.

13. The kit of claim 11 wherein the seat mounting bracket is for pivotable connection to the frame.

14. The kit of claim 13 further comprising a biasing member for connecting the frame and the seat mounting bracket, the biasing member for biasing the seat toward a generally horizontal orientation.
